(19) United States
(12) Patent Application Publication
(10) Pub. No.: US 2013/0147310 A1
(43) Pub. Date: Jun. 13, 2013

(54) SLIP RING

(71) Applicant: ALSTOM TECHNOLOGY LTD, Baden (CH)

(72) Inventor: Hossein Safari Zadeh, Othmarsingen (CH)

(73) Assignee: ALSTOM TECHNOLOGY LTD, Baden (CH)

(21) Appl. No.: 13/707,892

(22) Filed: Dec. 7, 2012

(30) Foreign Application Priority Data
Dec. 9, 2011 (EP) 11192728.1

(51) Int. Cl. H01R 39/08

(52) U.S. Cl. CPC H01R 39/08
USPC 310/232

(57) ABSTRACT

A slip ring includes a first element and a second element movable relative to each other, a chamber between the first and second elements, a metal or alloy in the chamber. The metal or alloy is liquid or becomes liquid under operating conditions. A passage is connected to the chamber between the first and second element. An outer chamber is connected to the passages. The outer chamber is filled with a sealing fluid for the chamber.

### INCORPORATION BY REFERENCE

The following documents are incorporated herein by reference as if fully set forth: EP Patent Application No. 11192728.1, filed Dec. 9, 2011.

### FIELD OF INVENTION

The present disclosure relates to a slip ring. In particular, the slip ring is connected to a shaft of an electric machine such as a synchronous or asynchronous generator or motor.

### BACKGROUND

Electric machines 1 (FIG. 5) include a stator 2 and a rotor 3. For example the electric machine can be an electric generator (for example a synchronous electric generator) but in different examples the electric machine can be an asynchronous electric generator, a synchronous or asynchronous electric motor, etc.

From each end of the rotor 3 a shaft 4 extends supported by bearings 5a, 5b, 5c. Usually the shaft 4 at the driven end of the rotor is supported by one bearing 5a and the other shaft 4 at the non driven end of the rotor is supported by two bearings 5b, 5c.

Between the two bearings 5b, 5c connected to the shaft 4 at the non driven end of the rotor 3, a slip ring 8′ is connected.

Traditionally the slip ring 8′ includes ring contacts 9 (one, two or more) connected to the shaft 4 and brushes 10 sliding associated to the ring contacts 10.

This slip ring 8′ is widely used but the current that it can carry is limited, mainly because of the carbon brushes.

For this reason U.S. Pat. No. 4,047,063 discloses a slip ring with a first and second elements movable to each other and defining a chamber in-between; in this chamber a liquid metal is contained to guarantee electric contact between the first and second elements.

In order to prevent metal vapor leakage from the sides of the chamber between the first and second elements, passages are provided for the introduction of a gas in the chamber and for discharge of this gas and metal vapor from the chamber.

During operation this structure can be troubling, because the gas can contaminate the liquid metal and alter its features.

In addition, centrifugal forces acting on the gas could cause a mixing of the gas with the liquid metal, preventing correct electric power transport between the first and second elements.

### SUMMARY

An aspect of the disclosure includes providing a slip ring with a liquid metal having a reduced risk of being contaminated from or mixed to a sealing gas for sealing the slip ring.

These and further aspects are attained by providing a slip ring in accordance with the accompanying claims.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of the slip ring (only one contact, the slip ring usually includes at least two contacts as shown in FIG. 7);

FIG. 2 shows a cross section of a particular of FIG. 1;

FIGS. 3 and 4 show alternative solutions to the slip ring of FIG. 1;

FIG. 5 shows an electric generator with known a slip ring;

FIG. 6 shows an electric generator with the slip ring of the disclosure;

FIG. 7 shows a longitudinal section of the slip ring of the disclosure;

FIG. 8 shows a perspective view of the slip ring of the disclosure;

FIGS. 9 and 10 show different embodiments of an electric generator with the slip ring of the disclosure.

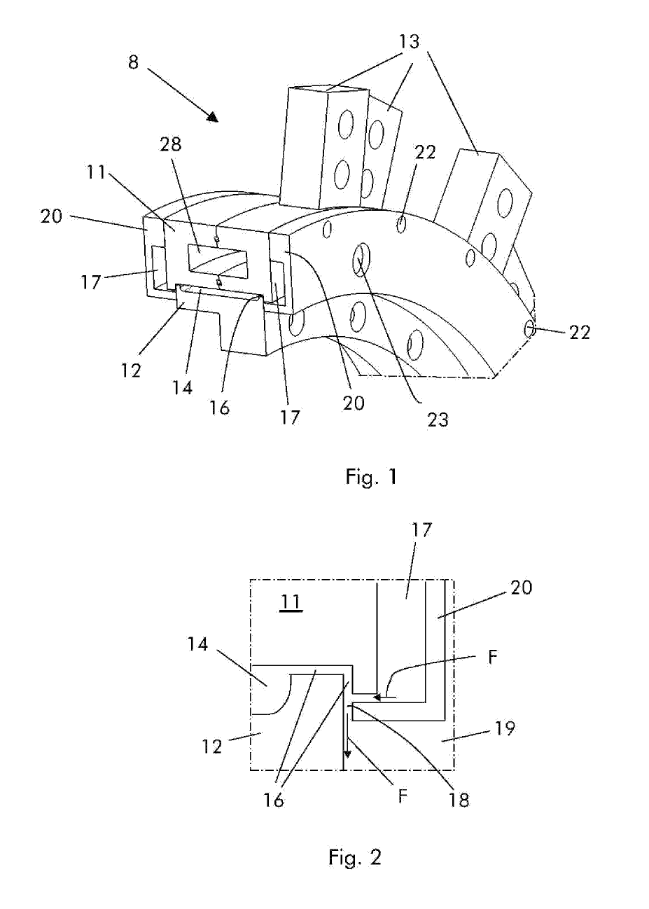

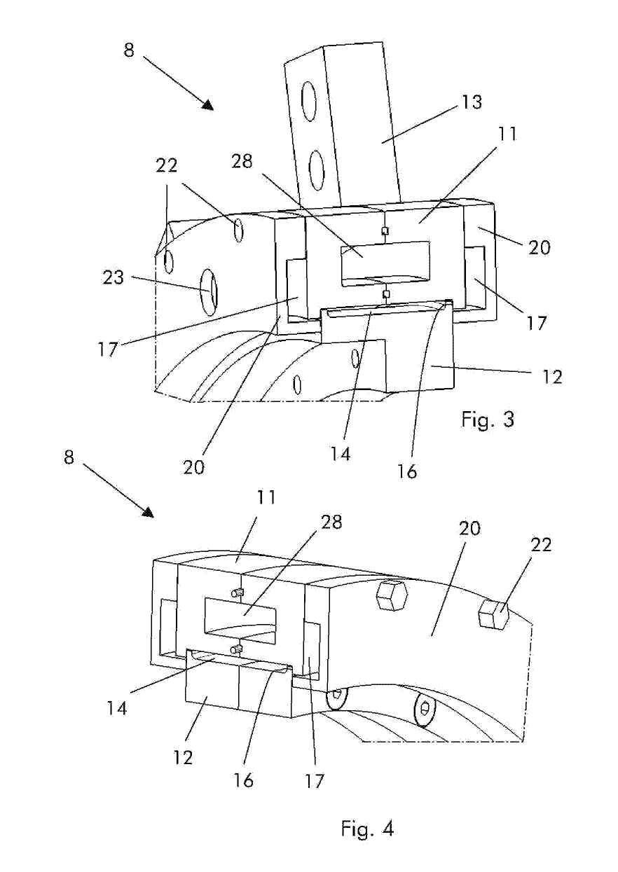

### DETAILED DESCRIPTION OF EMBODIMENTS

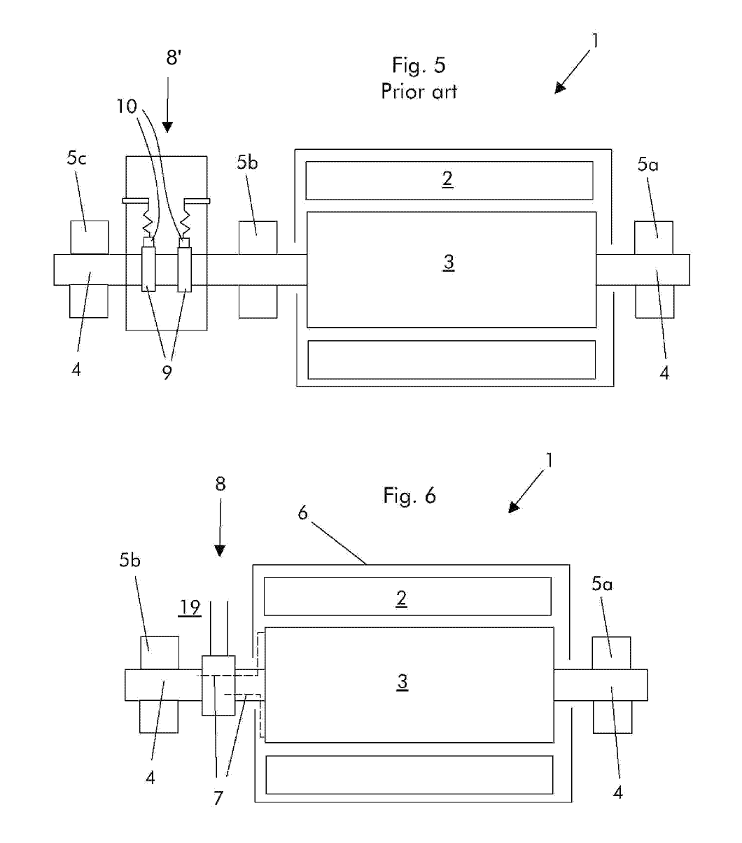

FIG. 6 shows an electric machine 1; the electric machine 1 can be a turbogenerator (i.e. an electric synchronous generator to be connected to a gas turbine or a steam turbine); in different examples the electric machine can also be a hydro generator (i.e. an electric synchronous generator to be connected to a hydro turbine) or an asynchronous electric generator or a synchronous or asynchronous motor or also a different rotating electric machine.

The electric machine 1 includes a stator 2 and a rotor 3. From each end of the rotor 3, a shaft 4 projects. The shafts 4 are supported by bearings 5a, 5b that are typically positioned outside of a casing 6 of the generator 1.

The driven end of the generator 1 has one bearing 5a and likewise the non driven end of the generator has one bearing 5b (at the non driven end two bearings like in the known generators can be provided).

Between the bearing 5b and the casing 6 a slip ring 8 is provided. The slip ring 8 receives electric power from an exciter and transfers the electric power to a conductive lead 7 connected to the winding of the rotor. Naturally, the slip ring 8 can also be provided between the bearing 5a and the casing 6 or within the casing 6 (at the side of the bearing 5a and/or 5b).

The slip ring 8 comprises a first element 11 and a second element 12 movable relative to each other; as shown in the figures the first element 11 is a fixed element and is provided with plugs 13 for the connection of the conductors providing electric power (for example coming from the exciter) and the second element 12 is connected to the shaft 4 (at the driven or non driven end of the electric machine 1 according to the design).

Between the first and second elements 11, 12 a chamber 14 is defined. The chamber 14 contains a metal or alloy, preferably the metal or alloy are liquid or become liquid under operating conditions.

In a possible embodiment the metal or alloy has a melting point below 130° C., preferably between 40-130° C. As an example, the liquid metal or alloy is AIM 47® (alloy containing Bi, Cd, In, Pb, Sn) or AIM 70® (alloy containing Bi, Cd, Pb, Sn) or galinstan or a Woods Alloy.

A passage 16 is connected to the chamber 14 between the first and second element 11, 12; each passage 16 is for example defined by a slit or gap.

The slip ring 8 also has an outer chamber 17 connected to the passages 16 at each side of the chamber 14; for example the outer chambers 17 run parallel to the passages 16). These outer chambers 17 are filled with a pressurized sealing fluid for the chamber 14; the sealing fluid is preferably a gas.

Each outer chamber 17 has one or more discharge passages 18 connected to the outside of the outer chamber 17. In addition, the discharge passages 18 are preferably not connected to the chamber 14. As shown in the figures, the discharge passages 18 are preferably connected to zones 19 that house the slip ring 8; for example this zone can be included in a housing, but this is not mandatory.

Each outer chamber 17 is defined by a third element 20 and the discharge passages 18 are defined by a gap between the second element 12 and the third element 20.

In contrast, the third element 20 is fixed to and supported by the first element 11 for example by means of screws 22. Naturally the element 20 can also be fixed to a housing 24 of the slip ring or casing 6.

The outer chamber 17 is provided with one or more inlets 23 for the sealing fluid.

In case the slip ring 8 is enclosed in a housing 24 housing a pressurized gas, the inlets 23 can be distributed (for example evenly distributed) over the circumference of the third elements 20. The housing 24 is then connected to a sealing fluid supply 25.

Alternatively, when for example no housing 24 for the slip ring 8 is provided, the inlets 23 can be one or more and can be connected via pipes to a sealing fluid supply 25.

In the cases above the sealing fluid supply 25 can include a tank and a pump. The sealing fluid supply 25 can be connected to a heat exchanger 27 to regulate the temperature of the sealing fluid before it is provided to the outer chambers 17. The heat exchanger 27 can cool and/or heat the sealing fluid.

In addition, the first element 11 and/or the second element 12 can have one or more ducts 28 connectable to a fluid supply 30.

This fluid supply 30 for the ducts 28 is preferably connected to a heat exchanger 31 to regulate the temperature of the fluid before it is provided to the ducts 28.

In the cases above the heat exchangers 27, 31 can be of any type and can include water exchanger and/or electric resistances and/or heat pumps and/or frigorific circuits, etc.

In addition, the fluid supplied to the one or more ducts 28 can also be the sealing fluid. In this case instead of different fluid supplies 25, 30, only one fluid supply (for example fluid supply 25) can be provided. In this case, one heat exchanger (for example heat exchanger 27) for the fluid supplied to both the outer chambers 17 and ducts 28 can be provided; alternatively the fluid coming from the single fluid supply can be carried to separate heat exchangers (like the heat exchangers 27, 31) and then to the outer chambers 17 and ducts 28.

The slip ring 8 can also comprise a control unit 35 connected to a sensor 36. The sensor 36 is arranged to measure a temperature indicative of the temperature of the metal or alloy in the chamber 14 (for example it can measure the temperature of the first element 11). The control unit 35 is then connected to one or both the heat exchangers 27, 31 to regulate the temperature of the sealing fluid and/or fluid on the basis of the detected temperature.

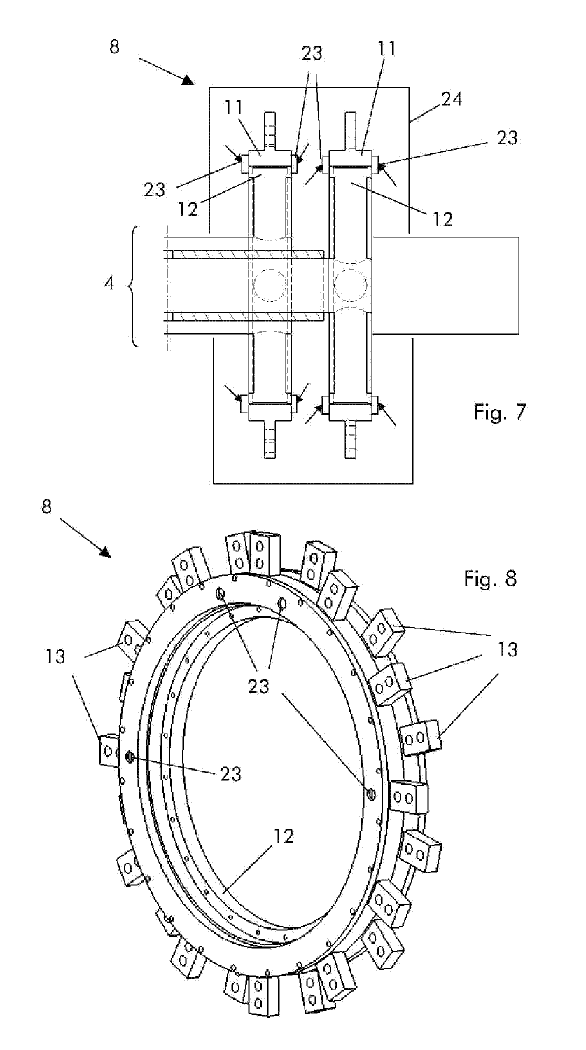

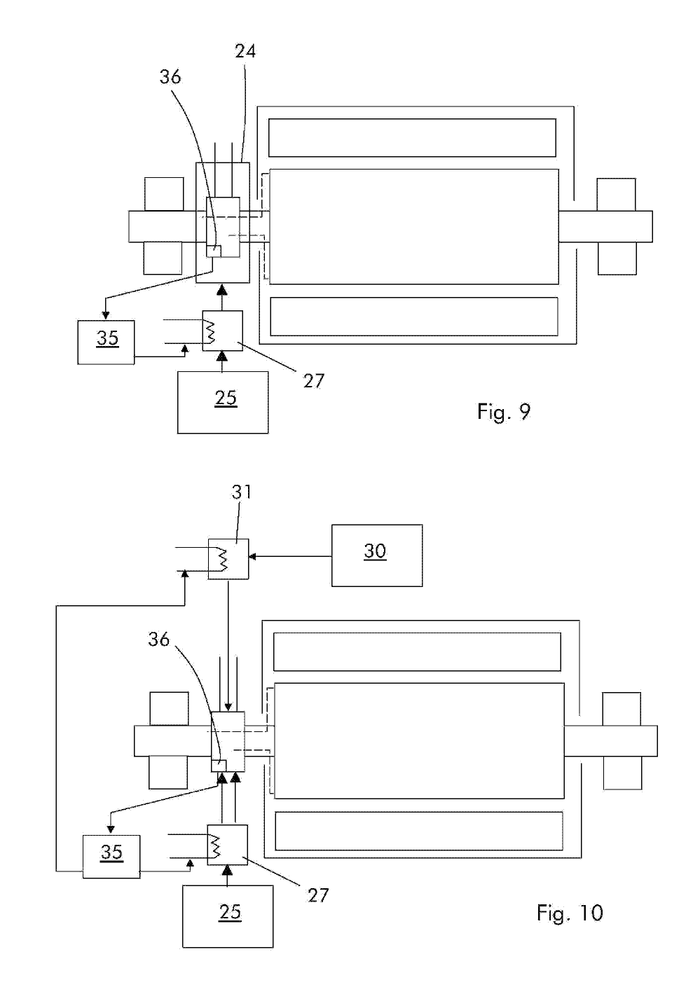

The slip ring can include one or more first and second elements; for example FIG. 7 shows a slip ring 8 with two first element 11 and two second elements 12; any number of elements 11, 12 is anyhow possible.

The operation of the slip ring is apparent from that described and illustrated and is substantially the following.

The slip ring 8 (with or without the housing 24) requires a much smaller space that traditional slip ring, because of:

the large current density that can pass through the first and second elements 11, 12 (that can be made out of copper or any other metal or alloy having good electric conductivity) and liquid metal, and

the particular structure with the third elements 20 that prevent leakages and at the same time allow heating or cooling of the liquid metal or alloy.

For these reasons, since the space required by the slip ring 8 is much smaller than in a known slip ring (either with brushes or liquid metal) the electric machine can use only two bearings 5a, 5b, in other words the electric machine can also have one bearing at the shaft at its driven end and another bearing at the shaft at the non driven end.

The operation is described with reference to an electric generator; operation for different electric machines is similar. During operation electric power is supplied from the exciter to the plugs 13 and from the plugs 13 to the first element 11, the liquid metal or alloy and to the second element 12. From the second element 12 electric power is then transferred to the lead conductor 7 and rotor winding.

During operation sealing fluid is provided in the outer chambers 17. The sealing fluid leaks through the discharge passages 18 and seals the passage 16, preventing liquid metal or alloy leakage. The liquid metal or alloy is preferably chosen such that at still stand it is solid, this allows easy assembling and maintenance of the slip ring 8, but at the temperatures usually reached during operation it is liquid.

For this reason, before the electric machine 1 is operated, the sealing fluid and/or fluid heated at an adequate temperature to allow liquid metal or alloy melting is provided into the outer chambers 17 and/or ducts 28.

Then, during operation, since the slip ring 8 generates heat that must be dissipated (in particular when the current density is high or very high) the sealing fluid through the outer chambers 17 and/or fluid through the ducts 28 can be used as a cooling fluid.

In addition, since often the liquid metals or alloys have a preferred optimum temperature operating range, the sensor 35 and control unit 36 can be used to regulate the temperature of the sealing fluid through the outer chambers 17 and/or fluid through the ducts 28 to keep the temperature of the liquid metal or alloys contained in the chamber in the optimum range.

The slip ring 8 can also be housed inside the electric machine casing, due to its inherent maintenance free and capability of high current carrying.

Naturally the features described may be independently provided from one another. In practice the materials used and the dimensions can be chosen at will according to requirements and to the state of the art. It is understood, therefore, that this invention is not limited to the particular embodiments disclosed, but is intended to cover all modifications which are within the spirit and scope of the invention as defined by the appended claims; the above description; and/or shown in the attached drawings.

### REFERENCE NUMBERS

1 electric machine
2 stator
3 rotor
4 shaft
5a, b, c bearings
6 casing
7 conductive lead
8, 8′ slip ring
9 ring contact
10 brushes
11 first element
12 second element
13 plug
14 chamber
16 passage
17 outer chamber
18 discharge passage
19 zone
20 third element
23 inlet
24 housing
25 sealing fluid supply
27 heat exchanger
28 duct
31 heat exchanger
35 control unit
36 sensor

1. A slip ring comprising a first element and a second element movable relative to each other, a chamber between the first and second elements, a metal or alloy in the chamber, the metal or alloy being liquid or becomes liquid under operating conditions, the slip ring further comprising at least one passage connected to the chamber between the first and second element, an outer chamber connected to the at least one passage, the outer chamber being filled with a sealing fluid for the chamber.

2. The slip ring according to claim 1, wherein the outer chamber has at least one discharge passage connected to an exterior of the outer chamber.

3. The slip ring according to claim 2, wherein the at least one discharge passage is not connected to the chamber.

4. The slip ring according to claim 2, wherein the second element is connectable to a shaft and the outer chamber is defined by a third element, wherein the discharge passages are defined by a gap between the second element and the third element.

5. The slip ring according to claim 1, wherein the outer chamber is provided with at least one inlet for the sealing fluid.

6. The slip ring according to claim 5, further comprising a sealing fluid supply connected to at least an inlet.

7. The slip ring according to claim 6, further comprising a heat exchanger, wherein the sealing fluid supply is connected to the heat exchanger to regulate the temperature of the sealing fluid before it is provided to the outer chamber.

8. The slip ring according to claim 1, wherein at least one of the first element or the second element have at least one duct connectable to a fluid supply.

9. The slip ring according to claim 8, further comprising a heat exchanger, wherein the fluid supply for the at least one duct is connected to the heat exchanger to regulate the temperature of the fluid before it is provided to the at least one duct.

10. The slip ring according to claim 9, wherein the fluid supplied to the at least one duct is the sealing fluid.

11. The slip ring according to claim 7 further comprising a control unit connected to at least one sensor arranged to measure a temperature indicative of the temperature of the metal or alloy in the chamber, the heat exchanger connected to the sealing fluid supply and/or fluid supply to regulate the temperature of the sealing fluid or fluid on the basis of the detected temperature.

12. The slip ring according to claim 9 further comprising a control unit connected to at least one sensor arranged to measure a temperature indicative of the temperature of the metal or alloy in the chamber, the heat exchanger connected to the sealing fluid supply and/or fluid supply to regulate the temperature of the sealing fluid or fluid on the basis of the detected temperature.

13. The slip ring according to claim 1, wherein the slip ring is connected to shaft of an electric machine, which comprises a stator, a rotor and one bearing at each side of the rotor.

14. The slip ring according to claim 13, wherein the electric machine has a casing, and in that the slip ring is housed inside the electric machine casing.

15. The slip ring according to claim 13, further comprising a plurality of first and second elements.

16. The slip ring according to claim 1, wherein the outer chamber runs parallel to the passages.
